(19) United States
(12) Patent Application Publication
(10) Pub. No.: US 2026/0195044 A1
(43) Pub. Date: Jul. 9, 2026

(54) MEMORY DIE STATE TRANSITION TRACKING MECHANISM

(71) Applicant: Sandisk Technologies, Inc., Milpitas, CA (US)

(72) Inventors: Abhinandan Venugopal, Karnataka (IN); Amit Sharma, Karnataka (IN)

(21) Appl. No.: 19/015,515

(22) Filed: Jan. 9, 2025

(51) Int. Cl. G06F 3/06

(52) U.S. Cl. CPC G06F 3/061; G06F 3/0659; G06F 3/0679

(57) ABSTRACT

A memory die state transition tracker is included with a data storage device and is used to track a state transition of a memory die from a first state to a second state. When the state transition is detected, the memory die state transition tracker records timestamp information associated with the change in state. The memory die state transition tracker provides this information to a controller of the data storage device which enables the controller to recalibrate a scheduler of the data storage device. As a result, the scheduler can schedule tasks for a particular memory die based on timing parameters that are specific for that particular memory die.

### BACKGROUND

Data storage devices, such as NAND data storage devices, typically include a scheduler. The scheduler is part of a controller of the data storage device and is responsible for managing and optimizing a sequence and timing of various read, write and erase operations. The scheduler schedules these operations to enhance performance, ensure efficient resource utilization, and maintain data integrity.

The scheduler typically schedules the timing of operations or tasks based on an average estimate of an amount of time each operation or task will take. However, there are situations in which an operation or task to be performed on a particular memory die of the data storage device may take more time to complete than the allotted estimate. In other situations, the operation or task to be performed on the particular memory die may take less time to complete than the allotted estimate. Both of these situations lead to various inefficiencies. However, there is currently no practical way to update or change the estimate of the amount of time each task will take, as the actual amount of time an operation will take may vary from memory die to memory die.

Accordingly, it would be beneficial for a data storage device to update a program time of an operation or task and provide this information to a scheduler, which would enable the scheduler to schedule operations more efficiently when compared with current solutions.

### SUMMARY

The present disclosure describes a data storage device, such as a NAND data storage device, having a memory die state transition tracker. The memory die state transition tracker is used to track a state transition of a memory die from a first state to a second state and record timestamp information associated with the change in state. The memory die state transition tracker provides this information to a controller of the data storage device. The controller uses this information to update or recalibrate a scheduler with respect to the memory die.

For example, the memory die state transition tracker tracks die state transitions (e.g., a transition from a cache-busy state to a cache-ready state and/or a transition from a cache-ready state to a true-ready state) and determines and/or creates a timestamp associated with each transition. The timestamp information and/or the state transition information is fetched by the controller at the end of a variance window (e.g., a range of a variation of time observed in an amount of time it takes for an operation to be completed on a memory die). The scheduler is then updated based, at least in part, on a difference between the timestamp information and a mean time associated with the particular state to which the memory die transitioned.

For example, if the timestamp information is less than the mean time associated with the particular state, a program time associated with the memory die is set to a value that is lower than the mean time. However, if the timestamp information is greater than the mean time associated with the particular state, the program time associated with the memory die is set to a value that is higher than the mean time. The scheduler may then schedule tasks based on the updated program time.

Accordingly, examples of the present disclosure describe a method that includes detecting a state transition of a memory die from a first state to a second state. Timestamp information associated with the state transition of the memory die from the first state to the second state is then determined. Information associated with the second state, along with the timestamp information, is stored. The timestamp information and the information associated with the second state is fetched by a controller associated with the memory die. In an example, the controller utilizes the timestamp information and the information associated with the second state to recalibrate a scheduler associated with the controller.

Other examples describe a data storage device that includes a controller, a scheduler associated with the controller, a memory die and a memory die state transition tracker associated with the memory die. In an example, the memory die state transition tracker is operable to detect a state transition of the memory die and determine timestamp information associated with the state transition. The memory die state transition tracker is also operable to store information associated with the state transition and provide the timestamp information and the information associated with the state transition to the controller. When the controller receives the information, the controller uses at least one of the timestamp information and the information associated with the state transition to recalibrate a program time associated with the scheduler.

Still other examples describe a data storage device that includes a means for detecting a state transition of a memory die associated with the data storage device. The data storage device also includes a means for determining timestamp information associated with the state transition and a means for storing information associated with the state transition. In an example, the data storage device also includes a means for providing the timestamp information and the information associated with the state transition to a control means. The control means uses at least one of the timestamp information and the information associated with the state transition to recalibrate a program time associated with a scheduling means.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram of a system that includes a host device and a data storage device according to an example.

FIG. 2A illustrates how a memory die includes a number of memory blocks according to an example.

FIG. 2B illustrates how a memory block includes one or more pages according to an example.

FIG. 3 illustrates a memory die state transition tracker of a memory device according to an example.

FIG. 4A illustrates an operation timeline of a memory die according to an example.

FIG. 4B illustrates an updated operation timeline of the memory die according to an example.

FIG. 4C illustrates an updated operation timeline of the memory die according to another example.

FIG. 5 illustrates a method for storing timestamp information associated with a state transition according to an example.

FIG. 6 illustrates a method for recalibrating a scheduler according to an example.

FIG. 7 is a perspective view of a storage device that includes three-dimensional (3D) stacked non-volatile memory according to an example.

FIG. 8 is a block diagram of a data storage device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

As previously described, data storage devices, such as NAND data storage devices, typically include a scheduler. The scheduler is primarily responsible for managing and optimizing a sequence and timing of various read, write and erase operations. For example, initially all memory dies of the data storage device are idle or available/free. When the controller receives a program operation (e.g., a triple-level cell (TLC) operation), the scheduler schedules the program operation on one of the free memory dies. The scheduler (or firmware) starts a timer associated with the selected memory die equal to a program value of the program operation. The scheduler does not consider the particular memory die for another operation until the timer expires. With the help of these timers, the scheduler always knows if a memory die is free and can schedule any pending operations accordingly.

Typically, the scheduler schedules the timing of operations or tasks based on an average estimate of an amount of time each operation or task will take. This is referred to herein as a time to program (or tProg). Typically, the tProg is the same for each memory die.

When the estimated tProg is reached, the scheduler triggers a program status check. However, due to variations among memory dies, the actual tProg for operations on various memory dies may vary.

If the actual tProg is more than the estimated tProg, the status check polling would block a flash interface module (FIM) until the operation is actually complete. As a result, any other operation that was scheduled during the poll time on the same memory die, or a different memory die, would be delayed. Since multiple memory dies are connected to the FIM, this would disturb any tracking that occurs for estimated start times and/or estimated completion time of other operations, which would lead to various performance penalties.

In other examples, the actual tProg may be less than the estimated tProg. In this situation, the scheduler would not be aware of operations that complete early as any status checks would be issued once the estimated tProg is reached. This leads to ineffective utilization of the memory dies because one or more memory dies may be idle.

To address the above, the present disclosure describes a memory die state transition tracker for a data storage device. The memory die state transition tracker is part of a memory device of the data storage device and is used to track a state transition of a memory die from a first state to a second state. The memory die state transition tracker also records timestamp information associated with the change in state. The memory die state transition tracker provides this information to a controller of the data storage device. The controller uses this information to update or recalibrate a scheduler with respect to the memory die.

For example, the memory die state transition tracker tracks die state transitions (e.g., a transition from a cache-busy state to a cache-ready state and/or a transition from a cache-ready state to a true-ready state) and determines and/or creates a timestamp associated with each transition. The timestamp information and/or the state transition information is fetched by and/or provided to the controller at the end of a variance window (e.g., a range of a variation of time observed in an amount of time it takes for an operation to be completed on a memory die). A tProg associated with the memory die is then updated based, at least in part, on a difference between the timestamp information and a mean time associated with the particular state to which the memory die transitioned. As a result, the actual tProg of a memory die is based on real-time data and can be updated accordingly.

In accordance with the above, many technical benefits may be realized including, but not limited to, enabling timing corrections on in-progress operations which improves operation performance when compared with current solutions, reducing an amount of time a memory die is idle in situations in which an actual tProg is less than the estimated tProg and improving scheduling and polling operations when the actual tProg is greater than the estimated tProg.

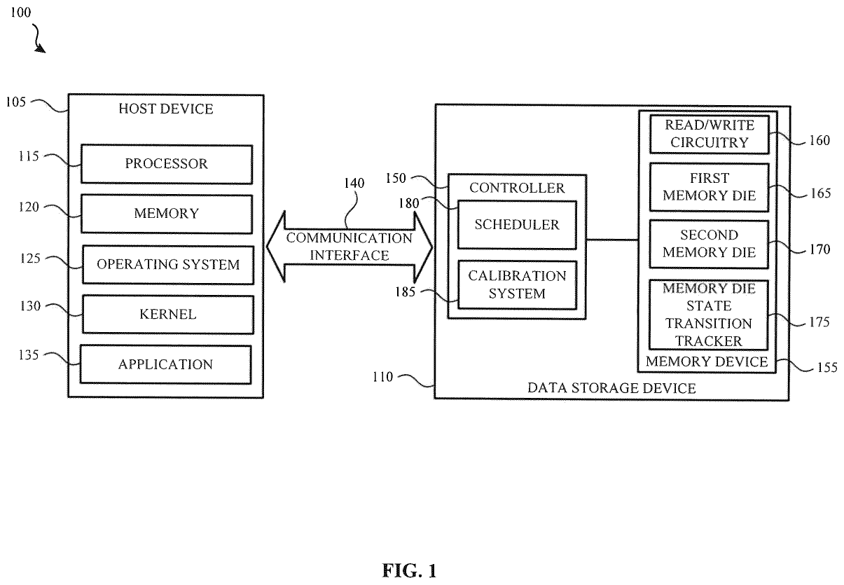

These benefits, along with other examples, will be shown and described in greater detail with respect to FIG. 1-FIG. 8.

FIG. 1 is a block diagram of a system 100 that includes a host device 105 and a data storage device 110 according to an example. In an example, the host device 105 includes a processor 115 and a memory 120 (e.g., main memory). The memory 120 may include or otherwise be associated with an operating system 125, a kernel 130 and/or an application 135.

The processor 115 executes various instructions, such as, for example, instructions from the operating system 125 and/or the application 135. The processor 115 may include circuitry such as a microcontroller, a Digital Signal Processor (DSP), an Application-Specific Integrated Circuit (ASIC), a Field Programmable Gate Array (FPGA), hard-wired logic, analog circuitry and/or various combinations thereof. In an example, the processor 115 may include a System on a Chip (SoC).

In an example, the memory 120 can be used by the host device 105 to store data. The data that is used, or executed by, the processor 115. Data stored in the memory 120 may include instructions provided by the data storage device 110 via a communication interface 140. The data stored in the memory 120 may also include data used to execute instructions from the operating system 125 and/or one or more applications 135. The memory 120 may be a single memory or may include multiple memories, such as, for example one or more non-volatile memories, one or more volatile memories, or a combination thereof.

In an example, the operating system 125 may create a virtual address space for the application 135 and/or other processes executed by the processor 115. The virtual address space may map to locations in the memory 120. The operating system 125 may also include or otherwise be associated with a kernel 130. The kernel 130 may include instructions for managing various resources of the host device 105 (e.g., memory allocation), handling read and write requests and so on.

The communication interface 140 communicatively couples the host device 105 and the data storage device 110. The communication interface 140 may be a Serial Advanced Technology Attachment (SATA), a PCI express (PCIe) bus, a Small Computer System Interface (SCSI), a Serial Attached SCSI (SAS), Ethernet, Fibre Channel, or Wi-Fi. As such, the host device 105 and the data storage device 110 need not be physically co-located and may communicate over a network such as a Local Area Network (LAN) or a Wide Area Network (WAN), such as the internet. In addition, the host device 105 may interface with the data storage device 110 using a logical interface specification such as Non-Volatile Memory express (NVMe) or Advanced Host Controller Interface (AHCI).

The data storage device 110 includes a controller 150 and a memory device 155. In an example, the controller 150 is communicatively coupled to the memory device 155. The memory device 155 includes one or more memory dies (e.g., first memory die 165 and second memory die 170). Although memory dies are specifically mentioned, the memory device 155 may include any non-volatile memory device, storage device, storage elements or storage medium including NAND flash memory cells and/or NOR flash memory cells.

The memory cells can take the form of solid-state (e.g., flash) memory cells and can be one-time programmable, few-times programmable, or many-times programmable. Additionally, the memory cells may be single-level cells (SLCs), multi-level cells (MLCs), triple-level cells (TLCs), quad-level cells (QLCs), penta-level cells (PLCs), and/or use any other memory technologies. The memory cells may be arranged in a two-dimensional configuration or a three-dimensional configuration.

In an example, the data storage device 110 is attached to or embedded within the host device 105. In another example, the data storage device 110 is implemented as an external device or a portable device that can be communicatively or selectively coupled to the host device 105. In yet another example, the data storage device 110 is a component (e.g., a solid-state drive (SSD)) of a network accessible data storage system, a network-attached storage system, a cloud data storage system, or the like.

As previously indicated, the memory device 155 of the data storage device 110 includes a first memory die 165 and a second memory die 170. Although two memory dies are shown, the memory device 155 may include any number of memory dies (e.g., one memory die, two memory dies, eight memory dies, or another number of memory dies). In an example, each memory die is associated with, and transitions between, a number of different states. For example, the first memory die 165 transitions between a cache-busy state to a cache-ready state. The first memory die 165 may also transition from the cache-ready state to a true-ready state. Although specific states are described, these are for example purposes. Additionally, each memory die is associated with a time to program (or tProg) which is an expected amount of time required or needed to complete a particular operation on the memory die.

The memory device 155 also includes support circuitry. In an example, the support circuitry includes read/write circuitry 160. The read/write circuitry 160 supports the operation of the memory dies of the memory device 155. Although the read/write circuitry 160 is depicted as a single component, the read/write circuitry 160 may be divided into separate components, such as, for example, read circuitry and write circuitry. The read/write circuitry 160 may be external to the memory dies of the memory device 155. In another example, one or more of the memory dies may include corresponding read/write circuitry 160 that is operable to read data from and/or write data to storage elements within one individual memory die independent of other read and/or write operations on any of the other memory dies.

In an example, one or more of the first memory die 165 and the second memory die 170 include one or more planes and each plane may have one or more memory blocks. In an example, each memory block includes one or more memory cells. A block of memory cells is the smallest number of memory cells that are physically erasable together. In an example and for increased parallelism, each of the blocks may be operated or organized in larger blocks or metablocks. For example, one block from different planes of memory cells may be logically linked together to form a metablock.

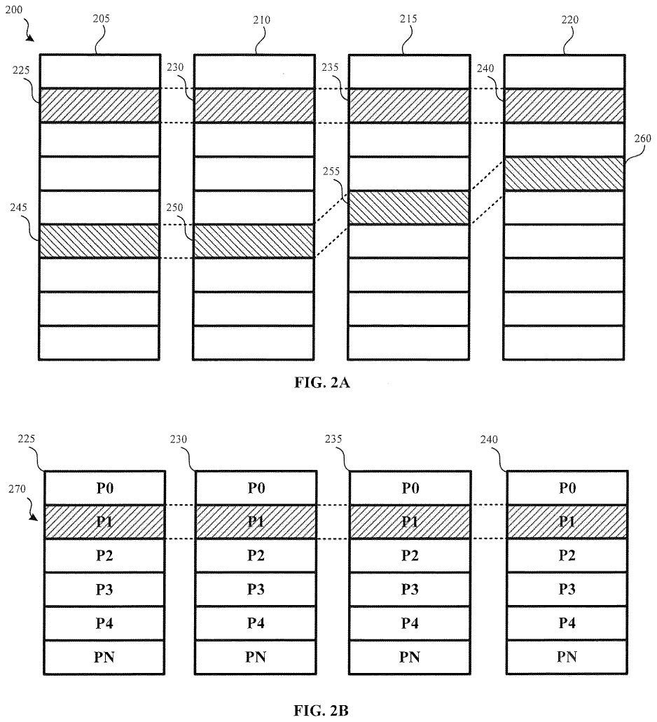

For example and referring to FIG. 2A, a memory device 200 (e.g., a storage element, a memory die, a non-volatile memory device) includes four planes or sub-arrays (e.g., a first plane 205, a second plane 210, a third plane 215, and a fourth plane 220). In an example, the planes are integrated on a single memory die, are provided on two different memory dies (e.g., two planes on each memory die) or are provided on four separate memory dies. Although four planes are shown and described, the memory device 200 may have any number of planes and/or memory dies.

In an example, the planes are divided into memory blocks consisting of memory cells. As shown in FIG. 2A, the rectangles represent each memory block, such as memory block 225, memory block 230, memory block 235 and memory block 240. There may be dozens or hundreds of memory blocks in each plane of the memory device 200. In an example, each memory block is a unit of erase and is sometimes referred to as an erase block. For example, memory block 225, memory block 230, memory block 235 and memory block 240 include a minimum number of memory cells that are erased together.

In addition, various memory blocks may be logically linked or grouped together (e.g., using a table in or otherwise accessible by the controller 150) to form a metablock. A metablock may be written to, read from and/or erased as a single unit. For example, memory block 225, memory block 230, memory block 235 and memory block 240 may form a first metablock while memory block 245, memory block 250, memory block 255 and memory block 260 may form a second metablock. The memory blocks used to form a metablock need not be restricted to the same relative locations within their respective planes.

In an example, each memory block may be divided, for operational purposes, into pages of memory cells, such as illustrated in FIG. 2B. For example, the memory cells of memory block 225, memory block 230, memory block 235 and memory block 240 are divided into N different pages (shown as P0-PN). Although a specific number of pages are shown in FIG. 2B, a memory block may have any number of pages of memory cells within each memory block.

In an example, a page is a unit of data programming within the memory block. Each page includes the minimum amount of data that can be programmed at one time. The minimum unit of data that can be read at one time may be less than a page. A metapage 270 is illustrated in FIG. 2B as being formed of one physical page from memory block 225, memory block 230, memory block 235 and memory block 240. In the example, shown, the metapage 270 includes page P1 in each of the four memory blocks. However, the pages of the metapage 270 need not have the same relative position within each of the memory blocks. A metapage 270 may be the maximum unit of programming within a memory block.

The memory blocks disclosed in FIG. 2A-FIG. 2B are referred to herein as physical memory blocks because they relate to groups of physical memory cells. As used herein, a logical memory block is a virtual unit of address space defined to have the same size as a physical memory block. Each logical memory block includes a range of logical memory block addresses (LBAs) that are associated with data received from a host. The LBAs are then mapped to one or more physical memory blocks in the data storage device 110 where the data is physically stored.

The memory device 155 also includes a memory die state transition tracker 175. In an example, the memory die state transition tracker 175 is associated with a state machine of the memory device 155. The memory die state transition tracker 175, in combination with the state machine, tracks a state transition of the first memory die 165 and/or the second memory die 170. The memory die state transition tracker 175 also records a timestamp associated with each state transition. In an example, the timestamp is a reference counter that is associated with one or more registers of each memory die.

When the state transition of a particular memory die is detected and the timestamp is recorded, the memory die state transition tracker 175 may provide that information to the controller 150. The controller 150 may use that information to update and/or recalibrate a scheduler 180. For example, and as will be described in greater detail herein, the information is provided to and/or fetched by a calibration system 185 of the controller 150. The calibration system 185 uses the timestamp information and the state transition information associated with the particular memory die to update a tProg of the memory die. In an example, the tProg of the memory die is associated with a particular state.

In an example, the data storage device 110 includes a single controller 150. However, in other examples, the data storage device 110 can include multiple controllers. In such an example, a first controller executes a first number and/or type of commands while a second controller executes a second number and/or type of commands. The controllers may operate in parallel and/or independently.

The controller 150 is communicatively coupled to the memory device 155 via a bus, an interface or other communication circuitry. In an example, the communication circuitry may include one or more channels to enable the controller 150 to communicate with the first memory die 165 and/or the second memory die 170 of the memory device 155. In another example, the communication circuitry may include multiple distinct channels which enables the controller 150 to communicate with the first memory die 165 independently and/or in parallel with the second memory die 170 of the memory device 155.

The controller 150 receives data and/or instructions from the host device 105. In an example, the controller 150 can receive one or more read commands, one or more write commands and/or one or more erase commands. In examples, the controller 150 sends data to and/or receives data from the host device 105 via the communication interface 140. The controller 150 also sends data and/or commands to, and/or receive data from, the memory device 155.

For example, the controller 150 sends data and a corresponding write command to the memory device 155 to cause the memory device 155 to store data at a specified address (or a memory die) of the memory device 155. In an example, the write command specifies a physical address of a portion of the memory device 155. For example, when data is received from the host device 105, the data is written sequentially on a targeted memory die (e.g., a metablock of the targeted memory die). A time at which the data is written to a targeted memory die is governed by the scheduler 180. For example, the scheduler determines when to schedule the write operations(s) on the targeted memory die based on one or more pending tasks or operations.

The controller 150 also sends one or more read commands to the memory device 155 and/or one or more erase commands to the memory device 155. In an example, the read command specifies the physical address of a portion of the memory device 155 at which the data is stored. In an example and as previously described, each operation is associated with a particular tProg. Additionally, the tProg may be different based on determined state of the memory die on which the operation is scheduled. Additionally, the tProg of each operation may be different based, at least in part, on variations that exist across the different memory dies.

As such, the controller 150 also includes, or is otherwise associated with, a calibration system 185. In an example, the calibration system 185 is a packaged functional hardware unit designed for use with other components/systems. In another example, the calibration system 185 is a portion of a program code (e.g., software or firmware) executable by a processor or processing circuitry. In yet another example, the calibration system 185 is a self-contained hardware and/or software component that interfaces with other components and/or systems. Although the calibration system 185 is shown as being part of the controller 150, the calibration system 185 may be separate from the controller 150.

In an example, the calibration system 185 is adapted to receive information from the memory die state transition tracker 175 such as previously described. When this information is received, the calibration system 185 updates or recalibrates the scheduler 180 by updating a tProg associated with one or more of the memory dies.

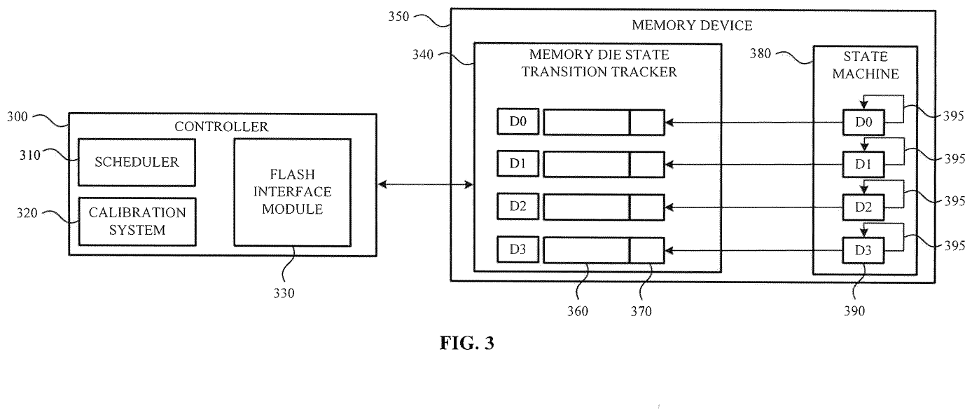

FIG. 3 illustrates a memory die state transition tracker 340 of a memory device 350 according to an example. In an example, the memory die state transition tracker 340 and the memory device 350 are similar to the memory die state transition tracker 175 and the memory device 155 shown and described with respect to FIG. 1. The memory die state transition tracker 340 interfaces with a controller 300 of a data storage device.

In an example, the controller 300 is similar to the controller 150 shown and described with respect to FIG. 1. For example, the controller 300 includes a scheduler 310 and a calibration system 320. The scheduler 310 and the calibration system 320 may operate in a similar manner as previously described.

The controller 300 also includes a flash interface module (FIM) 330. The FIM 330 facilitates movement of data between the controller and the various memory dies and oversees the reading and writing of data to and from the memory dies, ensuring that data is transferred efficiently.

In an example, the memory die state transition tracker 340 is associated with, or stores data associated with, a number of different memory dies 390. For example, the memory die state transition tracker 340 stores information associated with a first memory die D0, a second memory die D1, a third memory die D2 and a fourth memory die D3. Although four memory dies are shown and described, the memory die state transition tracker 340 may store information for a number of different memory dies. In an example, the FIM 330 is associated with each of the memory dies 390.

In an example, the information that is stored by the memory die state transition tracker 340 includes a timestamp 360 (or timestamp information) and a state transition information 370. The timestamp 360 may be a reference counter and the state transition information 370 may indicate when a particular memory die transitioned to a cache-ready state and/or to a true-ready state. As shown, the memory die state transition tracker 340 tracks and/or stores this information for each memory die.

The memory die state transition tracker 340 also interfaces with a state machine 380. In an example, the state machine 380 tracks a state (or a state transition (represented by the arrows 395) of each of the memory dies 390. For example, the state machine 380 tracks or determines when the first memory die D0, the second memory die D1, the third memory die D2 and/or the fourth memory die D3 transition from a cache-busy state to a cache-ready state. The state machine 380 also tracks or determines when the first memory die D0, the second memory die D1, the third memory die D2 and/or the fourth memory die D3 transition from the cache-ready state to a true-ready state.

In an example, when the state machine 380 detects or determines that at least one of the memory dies 390 has transitioned from a first state to a second state, the state machine 380 provides the transition information to the memory die state transition tracker 340. The memory die state transition tracker 340 records the state transition information 370 along with the timestamp 360 associated with the transition. The memory die state transition tracker 340 may also provide this information to the calibration system 320. In an example, the recalibration is triggered at the end of a variance window (e.g., a time deviation from a mean operation time sampled over multiple dies and/or samples) or a predefined percentage (e.g., 85%) of a of a variance window.

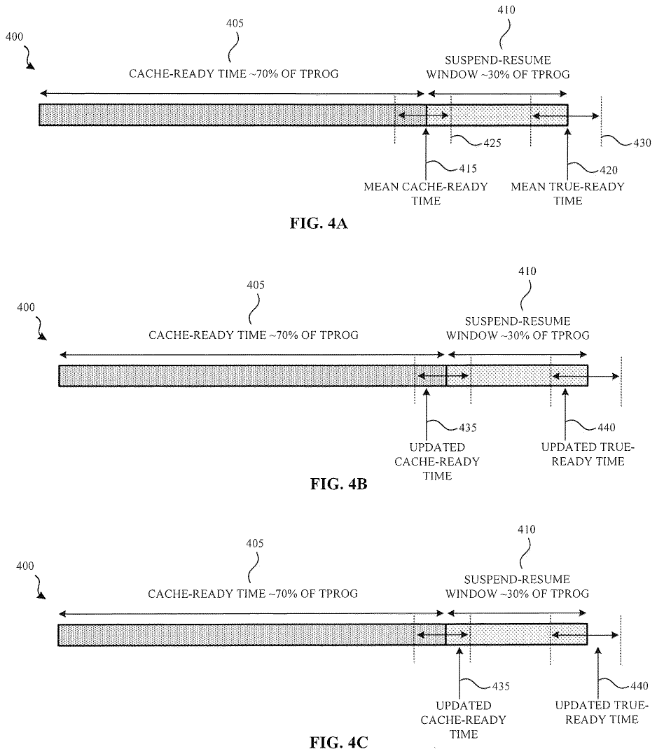

FIG. 4A illustrates an operation timeline 400 of a memory die according to an example. In an example and as will be described in greater detail with respect to FIG. 4B, the operation timeline 400 (or a scheduler responsible for executing operations based on the operation timeline 400) is updated using information obtained from a memory die state transition tracker, such as, for example, the memory die state transition tracker 175 shown and described with respect to FIG. 1.

In an example, a memory die has a predetermined cache-ready time 405. In an example, the cache-ready time 405 is equivalent to approximately seventy percent of tProg of the memory die. Additionally, the memory die has a predetermined suspend-resume window 410. In an example, the suspend-resume window 410 is a time interval of the tProg during which ongoing operations can be temporarily halted or suspended. The suspension allows other operations (e.g., higher priority operations) to be executed. When the other operation has been completed, the suspended operation is resumed. In an example, the suspend-resume window 410 is approximately thirty percent of the tProg. Although specific percentages are given, these are for example purposes only.

In an example, the suspend-resume window 410 is characterized based, at least in part, on a memory sample. For example and as previously explained, the suspend-resume window 410 may be a percentage (e.g., 30%, 40%) of the total tProg time. In some examples, tProg varies across wordlines, memory blocks, memory dies, and/or chips. However, a suspend-resume window 410 time to tProg time ratio will remain the same. For example, if a memory sample of wordlines has a 30% suspend-resume window 410 and the wordlines exhibit a tProg as 3000 microseconds (μs), the suspend-resume window 410 starts at 2100 μs (e.g., 3000 μs*0.7=2100 μs, the last 30% of tProg). For wordlines which exhibit tProg as 2800 μs, the suspend-resume window 410 starts at 1960 μs (e.g., 2800*0.7=1960 μs, the last 30% of tProg).

However, if an absolute time at which a memory die transitioned from cache-busy state to cache-ready state (e.g., the start of suspend-resume window 410) is known, the tProg, or the die state transition, from the cache-ready state to the true-ready state can be extrapolated. For example, the calibration system 185 (FIG. 1) utilizes an absolute time at which the memory die transitions between the cache-busy state to the cache-ready, provided by the memory die state transition tracker 175 (FIG. 1) to extrapolate and recalibrate a program completion time represented as the updated true ready time (shown in FIG. 4B and FIG. 4C).

The operation timeline 400 also includes a mean cache-ready time 415 and a mean true-ready time 420. The mean cache-ready time 415 is a mean time at which the memory die should transition from a cache-busy state to a cache-ready state. Likewise, the mean true-ready time 420 is a mean time at which the memory die should transition from the cache-ready state to the true-ready state.

The operation timeline 400 also includes one or more variance windows. In an example, the variance windows are a range of a variation of time observed in an amount of time it takes for an operation to be completed on the memory die. In an example, the mean cache-ready time 415 is associated with a first variance window 425 and the mean true-ready time 420 is associated with a second variance window 430. Additionally, when the scheduler is recalibrated, the updated cache-ready time may be contained within the first variance window 425 while the updated true-ready time may be contained within the second variance window.

In an example, and in order to recalibrate the scheduler with respect to the mean-cache ready time 415 of a particular memory die (e.g., the first memory die D0 of FIG. 3), the memory die state transition tracker provides a timestamp (or timestamp information) associated with a state transition in which the particular memory die transitioned from a cache-busy state to a cache-ready state. In an example, the timestamp associated with the state transition is fetched by a calibration system (e.g., calibration system 185 (FIG. 1)) of the data storage device.

The calibration system compares the timestamp associated with the state transition to the mean cache-ready time 415. If the timestamp is greater than the mean cache-ready time 415, the updated mean cache-ready time is updated to be greater than the mean cache-ready time 415 (e.g., moved farther back within the variance window 425). However, if the timestamp is less than the mean cache-ready time 415, the updated mean cache-ready time is updated to be less than the mean cache-ready time 415 (e.g., moved forward within the variance window 425). In an example, the same is true for the mean true-ready time 420.

For example and referring to FIG. 4B, FIG. 4B illustrates an updated operation timeline 400 of the memory die according to an example. In this example, the calibration system determined that the timestamp associated with the state transition was less than the mean cache-ready time 415. As a result, the updated mean cache-ready time 435, and/or the updated true-cache ready time 440, are updated such as shown. When operations are scheduled based on the memory die having the cache-ready state, the scheduler will base its scheduling and/or polling decisions based, at least in part, on the updated cache-ready time 435 and/or the updated true-ready time 440.

In an example, the use of timing values by the calibration system 185 (FIG. 1) is to recalibrate and/or update next and/or future events. However, in the process, the current time event is also updated. For example, the cache-ready time obtained from the memory die state transition tracker 175 (FIG. 1) is used to recalibrate or update the true-ready time of the same operation (e.g., represented as the updated true-ready time 440). In this process, the updated cache-ready time 435 is also updated. However, in some examples, the updated cache-ready time will have no effect since the cache-ready time has elapsed.

In another example, a true ready time of a current operation obtained from the memory die state transition tracker 175 can also be used to recalibrate a cache-ready time and/or a true-ready time of further operations (e.g., N+1 operations) on the same memory die. In an example, these updated times are represented as updated cache-ready time 435 and updated true-ready time 440. However, in some examples, the updated true-ready time 440 will have no effect since the true-ready time has elapsed. Thus, in some examples, a next and/or a future event is calibrated, the current time events may also be updated.

Referring back to FIG. 4A and as previously discussed, the scheduler can also update the true-ready time of the memory die. In an example, and in order to recalibrate the scheduler with respect to the mean true-ready time 420 of the particular memory die (e.g., the first memory die D0 of FIG. 3), the memory die state transition tracker provides a timestamp (or timestamp information) associated with a state transition in which the particular memory die transitioned from a cache-ready state to a true-ready state. In an example, the timestamp associated with the state transition is fetched by a calibration system (e.g., calibration system 185 (FIG. 1)) of the data storage device.

The calibration system compares the timestamp associated with the state transition to the mean true-ready time 420. If the timestamp is greater than the mean true-ready time 420, the updated true-ready time is updated to be greater than the mean true-ready time 420 (e.g., moved farther back within the variance window 430). However, if the timestamp is less than the mean true-ready time 420, the updated true-ready time is updated to be less than the mean true-ready time 430 (e.g., moved forward within the variance window 430).

For example and referring to FIG. 4C, the calibration system determined that the timestamp associated with the state transition from the cache-ready time to the true-ready time was greater than the mean true-ready time 420. As a result, the updated true-ready time 440 and/or the updated cache-ready time 435, is pushed back within the variance window 430. When other operations are scheduled based on the memory die having the true-ready state (or the cache-ready state), the scheduler will base its scheduling and/or polling decisions based, at least in part, on the updated true-ready time 440 and/or updated cache ready-time 435.

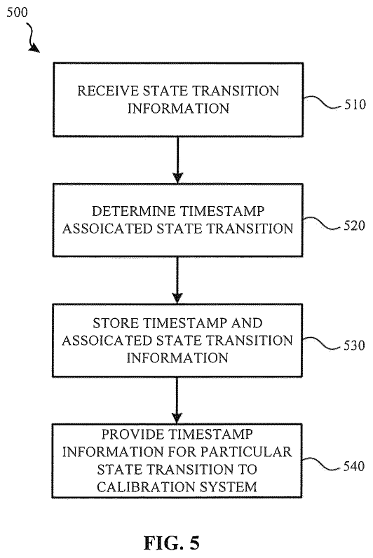

FIG. 5 illustrates a method 500 for storing timestamp information associated with a state transition according to an example. In an example, the method 500 is performed by a memory die state transition tracker, such as, for example, the memory die state transition tracker 175 shown and described with respect to FIG. 1.

In an example, the method 500 begins when state transition information for a particular memory die is received (510). For example, a state machine of a memory device may determine that one or more memory dies of the memory device have transitioned from a first state (e.g., a cache-busy state) to a second state (e.g., a cache-ready state). When this is detected, the state machine provides the state transition information to the memory die state transition tracker.

When the state transition information is received, the memory die state transition tracker determines (520) timestamp information associated with the state transition. In an example, the timestamp information is based, at least in part on a reference counter. The reference counter is a free-running counter which counts to a maximum value. Any overflow would cause the counter to reset to zero.

The memory die state transition tracker is configured to store (530) the timestamp information and the associated state transition information. This information is provided (540) to and/or fetched by a scheduling system when the scheduling system determines that the scheduler should be updated. In an example, the scheduling system determines whether the scheduler has bandwidth to perform the calibration such as previously described.

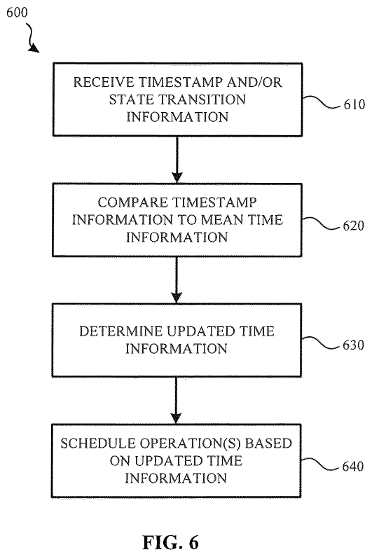

FIG. 6 illustrates a method 600 for recalibrating a scheduler according to an example. In an example, the method 600 is performed by a calibration system of a controller such as, for example, the calibration system 185 shown and described with respect to FIG. 1.

In an example, the method 600 begins when the calibration system receives (610) timestamp and/or state transition information. The timestamp and/or state transition information is received from a memory die state transition tracker such as, for example, the memory die state transition tracker 175 shown and described with respect to FIG. 1. In an example, the timestamp and/or the state transition information is fetched by and/or provided to the calibration system on demand. For example, the timestamp information is retrieved based, at least in part, on a “worst case” timing for a state transition (e.g., at the end and/or near the end of a variance window).

In another example, the timestamp information is retrieved at a “worst case” occurrence probability. This occurrence probability may be based, at least in part on a transition from a cache-busy state to a cache-ready state. In another example, the timestamp information is retrieved during a program operation on a wordline in which previous timing information is not available on the same or a similar operation. In an example, the timing will be at or near the end of variance window.

In an example, “near” the variance window may be used if under a threshold number of deviations exhibit significant variations, as these variations would cause a wider variance window. As such, consideration of the end of variance window could be comparably inefficient. In some examples, such as a cache-ready state transition to a true-ready state transition, information obtained from the end of the variance window will be accurate (e.g., as timings are on same operation which have already been calibrated, such as, for example, calibrations based on cache-ready times).

When the timestamp and/or the state transition information is received, the calibration system compares (620) the timestamp and/or the state transition information to mean time information associated with the state transition. For example, if the state transition information indicates that the memory die has transitioned from a cache-busy state to a cache-ready state, the scheduling system compares the timestamp information to a mean cache ready time (e.g., the mean cache-ready time 415 (FIG. 4)).

The calibration system then determines (630) updated time information based on the comparison. For example, the calibration system determines whether the time information should be increased or decreased when compared with the mean time information. The calibration system then updates the time information for future events accordingly. For example, updated true-ready times are updated when fetching and/or calibrating updated cache-ready times. When this is complete, operations are scheduled (640) based, at least in part, on the updated time information.

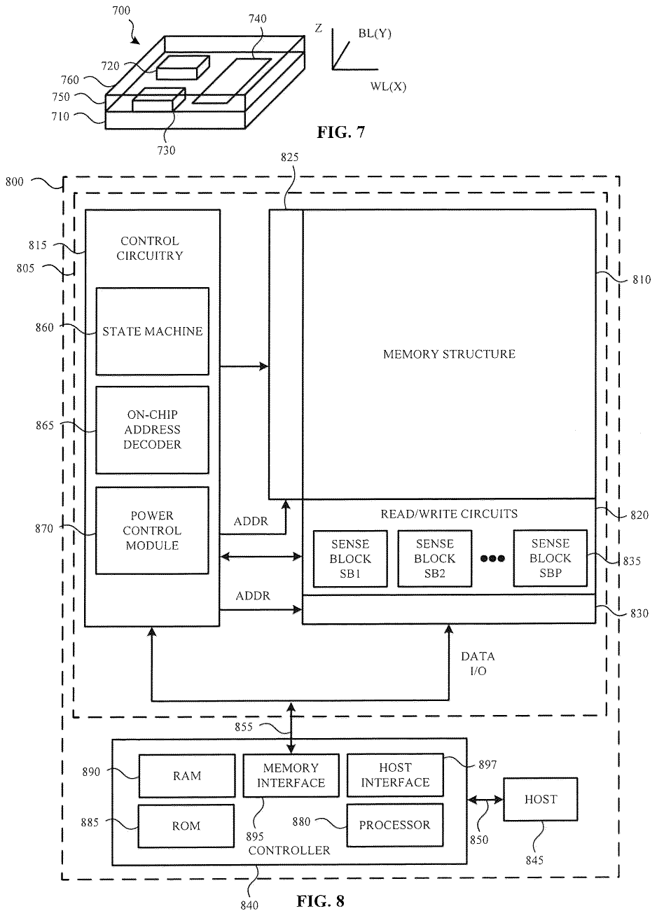

FIG. 7-FIG. 8 describe example storage devices that may be used with or otherwise implement the various features described herein. For example, the storage devices shown and described with respect to FIG. 7-FIG. 8 may include various systems and components that are similar to the systems and components shown and described with respect to FIG. 1. For example, the controller 822 shown and described with respect to FIG. 8 may be similar to the controller 150 of FIG. 1. Likewise, the memory dies 808 may be similar to the first memory die 165 and/or the second memory die 170 of FIG. 1.

FIG. 7 is a perspective view of a storage device 700 that includes three-dimensional (3D) stacked non-volatile memory according to an example. In this example, the storage device 700 includes a substrate 710. Blocks of memory cells are included on or above the substrate 710. The blocks include a first block (BLK0 720) and a second block (BLK1 730). Each block is formed of memory cells (e.g., non-volatile memory elements). The substrate 710 also includes a peripheral area 740 having support circuits that are used by the first block and the second block.

The substrate 710 also carries circuits under the blocks, along with one or more lower metal layers which are patterned in conductive paths to carry signals from the circuits. In an example, the blocks are formed in an intermediate region 750 of the storage device 700. The storage device also includes an upper region 760. The upper region 760 includes one or more upper metal layers that are patterned in conductive paths to carry signals from the circuits. Each block of memory cells includes a stacked area of memory cells. In an example, alternating levels of the stack represent wordlines. While two blocks are depicted, additional blocks may be used and extend in the x-direction and/or the y-direction.

In an example, a length of a plane of the substrate 710 in the x-direction represents a direction in which signal paths for wordlines or control gate lines extend (e.g., a wordline or drain-end select gate (SGD) line direction) and the width of the plane of the substrate 710 in the y-direction represents a direction in which signal paths for bit lines extend (e.g., a bit line direction). The z-direction represents a height of the storage device 700.

FIG. 8 is a block diagram of a data storage device 800 according to an example. In an example, the storage device 800 is similar to the 3D stacked non-volatile storage device 700 shown and described with respect to FIG. 7. In an example, the components depicted in FIG. 8 are electrical circuits. In an example, the storage device 800 includes one or more memory dies 805. Each memory die 805 includes a three-dimensional memory structure 810 of memory cells (e.g., a 3D array of memory cells), control circuitry 815, and read/write circuits 820. In another example, a two-dimensional array of memory cells may be used. The memory structure 810 is addressable by wordlines using a first decoder 825 (e.g., a row decoder) and by bit lines using a second decoder 830 (e.g., a column decoder). The read/write circuits 820 may also include multiple sense blocks 835 including SB1, SB2, . . . , SBp (e.g., sensing circuitry) which allow pages of the memory cells to be read or programmed in parallel. The sense blocks 835 may include bit line drivers.

In an example, a controller 840 is included in the same storage device 800 as the one or more memory dies 805. In another example, the controller 840 is formed on a die that is bonded to a memory die 805, in which case each memory die 805 may have its own controller 840. In yet another example, a controller die controls all of the memory dies 805. Although a single controller 840 is shown, the storage device 800 can include multiple controllers with each controller responsible for different operations described herein.

Commands and data are transferred between a host 845 and the controller 840 using a data bus 850. Additionally, commands and data are transferred between the controller 840 and one or more of the memory dies 805 by way of lines 855. In one example, the memory die 805 includes a set of input and/or output (I/O) pins that connect to lines 855.

The memory structure 810 also includes one or more arrays of memory cells. The memory cells are arranged in a three-dimensional array or a two-dimensional array. The memory structure 810 includes any type of non-volatile memory that is formed on one or more physical levels of arrays of memory cells having an active area disposed above a silicon substrate. The memory structure 810 may be in a non-volatile memory device having circuitry associated with the operation of the memory cells, whether the associated circuitry is above or within the substrate.

The control circuitry 815 works in conjunction with the read/write circuits 820 to perform memory operations (e.g., erase, program, read, and others) on the memory structure 810. The control circuitry 815 may include registers, ROM fuses, and other devices for storing default values such as base voltages and other parameters.

The control circuitry 815 also includes a state machine 860, an on-chip address decoder 865 and a power control module. The state machine 860 provides chip-level control of various memory operations, such as selecting a memory block for programming. The state machine 860 is programmable by software. In another example, the state machine 860 does not use software and is completely implemented in hardware (e.g., electrical circuits).

The on-chip address decoder 865 provides an address interface between addresses used by host 845 and/or the controller 840 to a hardware address used by the first decoder 825 and the second decoder 830. The power control module 870 controls power and voltages that are supplied to the wordlines and bit lines during memory operations. The power control module 870 may include drivers for wordline layers in a 3D configuration, select transistors (e.g., SGS and SGD transistors) and source lines. The power control module 870 may include one or more charge pumps for creating voltages. In an example, the power control module 870 helps ensure wordlines of the grown bad block described herein are programmed at the desired levels.

The control circuitry 815, the state machine 860, the on-chip address decoder 865, the first decoder 825, the second decoder 830, the power control module 870, the sense blocks 835, the read/write circuits 820, and/or the controller 840 may be considered one or more control circuits and/or a managing circuit that perform some or all of the operations described herein.

In an example, the controller 840, is an electrical circuit that may be on-chip or off-chip. Additionally, the controller 840 may include one or more processors 880, ROM 885, RAM 890, memory interface 895, and host interface 897, all of which may be interconnected. In an example, the one or more processors 880 is one example of a control circuit. Other examples can use state machines or other custom circuits designed to perform one or more functions. Devices such as ROM 885 and RAM 890 may include code such as a set of instructions. One or more of the processors 880 may be operable to execute the set of instructions to provide some or all of the functionality described herein.

Alternatively or additionally, one or more of the processors 880 may access code from a memory device in the memory structure 810, such as a reserved area of memory cells connected to one or more wordlines. The memory interface 895, in communication with ROM 885, RAM 890, and one or more of the processors 880, may be an electrical circuit that provides an electrical interface between the controller 840 and the memory die 805. For example, the memory interface 895 may change the format or timing of signals, provide a buffer, isolate from surges, latch I/O, and so forth.

The one or more processors 880 may issue commands to control circuitry 815, or any other component of memory die 805, using the memory interface 895. The host interface 897, in communication with the ROM 885, the RAM 895, and the one or more processors 880, may be an electrical circuit that provides an electrical interface between the controller 840 and the host 845. For example, the host interface 897 may change the format or timing of signals, provide a buffer, isolate from surges, latch I/O, and so on. Commands and data from the host 845 are received by the controller 840 by way of the host interface 897. Data sent to the host 845 may be transmitted using the data bus 850.

Multiple memory elements in the memory structure 810 may be configured so that they are connected in series or so that each element is individually accessible. By way of a non-limiting example, flash memory devices in a NAND configuration (e.g., NAND flash memory) typically contain memory elements connected in series. A NAND string is an example of a set of series-connected memory cells and select gate transistors.

A NAND flash memory array may also be configured so that the array includes multiple NAND strings. In an example, a NAND string includes multiple memory cells sharing a single bit line and are accessed as a group. Alternatively, memory elements may be configured so that each memory element is individually accessible (e.g., a NOR memory array). The NAND and NOR memory configurations are examples and memory cells may have other configurations.

The memory cells may be arranged in the single memory device level in an ordered array, such as in a plurality of rows and/or columns. However, the memory elements may be arrayed in non-regular or non-orthogonal configurations, or in structures not considered arrays.

In an example, a 3D memory structure may be vertically arranged as a stack of multiple 2D memory device levels. As another non-limiting example, a 3D memory array may be arranged as multiple vertical columns (e.g., columns extending substantially perpendicular to the major surface of the substrate, such as in the y direction) with each column having multiple memory cells. The vertical columns may be arranged in a two-dimensional arrangement of memory cells, with memory cells on multiple vertically stacked memory planes. Other configurations of memory elements in three dimensions can also constitute a 3D memory array.

In another example, in a 3D NAND memory array, the memory elements may be coupled together to form vertical NAND strings that traverse across multiple horizontal memory device levels. Other 3D configurations can be envisioned wherein some NAND strings contain memory elements in a single memory level while other strings contain memory elements which span through multiple memory levels. 3D memory arrays may also be designed in a NOR configuration and in a ReRAM configuration.

Accordingly, examples of the present disclosure describe a method, comprising: detecting a state transition of a memory die from a first state to a second state; determining timestamp information associated with the state transition of the memory die from the first state to the second state; storing information associated with the second state; storing the timestamp information; and providing the timestamp information and the information associated with the second state to a controller associated with the memory die, the controller utilizing the timestamp information and the information associated with the second state to recalibrate a scheduler associated with the controller. In an example, the timestamp information and the information associated with the second state is determined by the controller upon expiration of a variance window. In an example, the scheduler is recalibrated based, at least in part, on a comparison between the timestamp information and an estimated mean time associated with the second state. In an example, the state transition is at least one of a transition from a cache-busy state to a cache-ready state and a transition from a cache-ready state to a true-ready state. In an example, the timestamp information is determined based, at least in part, on information received from a state machine associated with the memory die. In an example, recalibrating the scheduler comprises updating a program time associated with the memory die. In an example, the timestamp information associated with the state transition of the memory die from the first state to the second state is fetched based, at least in part, on an occurrence probability.

Still other examples describe a data storage device, comprising: a controller; a scheduler associated with the controller; a memory die; and a memory die state transition tracker associated with the memory die and operable to: detect a state transition of the memory die; determine timestamp information associated with the state transition; store information associated with the state transition; and provide the timestamp information and the information associated with the state transition to the controller, the controller utilizing at least one of the timestamp information and the information associated with the state transition to recalibrate a program time associated with the scheduler. In an example, the timestamp information and the information associated with the state transition is determined by the controller upon expiration of a variance window. In an example, the scheduler is recalibrated based, at least in part, on a comparison between the timestamp information and an estimated mean time associated with the state transition. In an example, the state transition is at least one of a transition from a cache-busy state to a cache-ready state and a transition from a cache-ready state to a true-ready state. In an example, the timestamp information is determined based, at least in part, on information received from a state machine associated with the memory die. In an example, recalibrating the scheduler comprises updating a program time associated with the memory die. In an example, the controller is operable to fetch the timestamp information based, at least in part, on an occurrence probability.

Examples of the present disclosure also describe a data storage device, comprising: means for detecting a state transition of a memory die associated with the data storage device: means for determining timestamp information associated with the state transition; means for storing information associated with the state transition; and means for providing the timestamp information and the information associated with the state transition to a control means, the control means utilizing at least one of the timestamp information and the information associated with the state transition to recalibrate a program time associated with a scheduling means. In an example, the timestamp information and the information associated with the state transition is determined by the control means upon expiration of a variance window. In an example, the scheduling means is recalibrated based, at least in part, on a comparison between the timestamp information and an estimated mean time associated with the state transition. In an example, the state transition is at least one of a transition from a cache-busy state to a cache-ready state and a transition from a cache-ready state to a true-ready state. In an example, the timestamp information is determined based, at least in part, on information received from a state machine associated with the memory die. In an example, recalibrating the scheduling means comprises updating a program time associated with the memory die.

One of ordinary skill in the art will recognize that the technology described herein is not limited to a single specific memory structure, but covers many relevant memory structures within the spirit and scope of the technology as described herein and as understood by one of ordinary skill in the art.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this disclosure that do not depart from the broader scope of the claimed disclosure.

Aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

What is claimed is:

1. A method, comprising:
detecting a state transition of a memory die from a first state to a second state;
determining timestamp information associated with the state transition of the memory die from the first state to the second state;
storing information associated with the second state;
storing the timestamp information; and
providing the timestamp information and the information associated with the second state to a controller associated with the memory die, the controller utilizing the timestamp information and the information associated with the second state to recalibrate a scheduler associated with the controller.

2. The method of claim 1, wherein the timestamp information and the information associated with the second state is determined by the controller upon expiration of a variance window.

3. The method of claim 1, wherein the scheduler is recalibrated based, at least in part, on a comparison between the timestamp information and an estimated mean time associated with the second state.

4. The method of claim 1, wherein the state transition is at least one of a transition from a cache-busy state to a cache-ready state and a transition from a cache-ready state to a true-ready state.

5. The method of claim 1, wherein the timestamp information is determined based, at least in part, on information received from a state machine associated with the memory die.

6. The method of claim 1, wherein recalibrating the scheduler comprises updating a program time associated with the memory die.

7. The method of claim 1, wherein the timestamp information associated with the state transition of the memory die from the first state to the second state is fetched based, at least in part, on an occurrence probability.

8. A data storage device, comprising:
a controller;
a scheduler associated with the controller;
a memory die; and
a memory die state transition tracker associated with the memory die and operable to:
detect a state transition of the memory die;
determine timestamp information associated with the state transition;
store information associated with the state transition; and
provide the timestamp information and the information associated with the state transition to the controller, the controller utilizing at least one of the timestamp information and the information associated with the state transition to recalibrate a program time associated with the scheduler.

9. The data storage device of claim 8, wherein the timestamp information and the information associated with the state transition is determined by the controller upon expiration of a variance window.

10. The data storage device of claim 8, wherein the scheduler is recalibrated based, at least in part, on a comparison between the timestamp information and an estimated mean time associated with the state transition.

11. The data storage device of claim 8, wherein the state transition is at least one of a transition from a cache-busy state to a cache-ready state and a transition from a cache-ready state to a true-ready state.

12. The data storage device of claim 8, wherein the timestamp information is determined based, at least in part, on information received from a state machine associated with the memory die.

13. The data storage device of claim 8, wherein recalibrating the scheduler comprises updating a program time associated with the memory die.

14. The data storage device of claim 8, wherein the controller is operable to fetch the timestamp information based, at least in part, on an occurrence probability.

15. A data storage device, comprising:
means for detecting a state transition of a memory die associated with the data storage device;
means for determining timestamp information associated with the state transition;
means for storing information associated with the state transition; and
means for providing the timestamp information and the information associated with the state transition to a control means, the control means utilizing at least one of the timestamp information and the information associated with the state transition to recalibrate a program time associated with a scheduling means.

16. The data storage device of claim 15, wherein the timestamp information and the information associated with the state transition is determined by the control means upon expiration of a variance window.

17. The data storage device of claim 15, wherein the scheduling means is recalibrated based, at least in part, on a comparison between the timestamp information and an estimated mean time associated with the state transition.

18. The data storage device of claim 15, wherein the state transition is at least one of a transition from a cache-busy state to a cache-ready state and a transition from a cache-ready state to a true-ready state.

19. The data storage device of claim 15, wherein the timestamp information is determined based, at least in part, on information received from a state machine associated with the memory die.

20. The data storage device of claim 15, wherein recalibrating the scheduling means comprises updating a program time associated with the memory die.
